(19) United States
(12) Patent Application Publication
(10) Pub. No.: US 2013/0170322 A1
(43) Pub. Date: Jul. 4, 2013

(54) SYSTEMS AND METHODS FOR MARINE ANTI-FOULING

(71) Applicants: Robert Seth Hartshorne, Newmarket (GB); Gary John Tustin, Sawston (GB); Joseph Hannah, Hardwick (GB); David Neser, Asker (NO)

(72) Inventors: Robert Seth Hartshorne, Newmarket (GB); Gary John Tustin, Sawston (GB); Joseph Hannah, Hardwick (GB); David Neser, Asker (NO)

(73) Assignee: WESTERNGECO L.L.C., HOUSTON, TX (US)

(21) Appl. No.: 13/514,948

(22) PCT Filed: Nov. 15, 2010
(86) PCT No.: PCT/IB10/02929

§ 371 Date: Oct. 12, 2012

Related U.S. Application Data
(60) Provisional application No. 61/285,377, filed on Dec. 10, 2009.

(51) Int. Cl. C08G 18/83; G01V 1/20; B29C 47/00

(52) U.S. Cl. CPC C08G 18/83; B29C 47/0004; G01V 1/201
USPC 367/154; 525/453; 523/122; 525/185; 528/85; 156/244.13

(57) ABSTRACT

An anti-biofouling casing for a seismic streamer is described, the anti-biofouling casing comprising a polymer system comprising a hydrophobically-modified base polymer, the hydrophobically-modified base polymer comprising a base polymer having a backbone and a hydrophobically derivatized chain extender coupled to said backbone of said base polymer, wherein the the hydrophobically derivatized chain extender comprises a hydrophobic moiety. The anti-fouling casing comprises a hydrophobic surface the serves to prevent biofouling of the surface.

### BACKGROUND

The field of the invention is that of providing for the reduction of biofouling of marine equipment. In particular, methods and systems are provided for preventing biofouling of marine seismic streamers. The invention in particular relates to analysis via seismic methods but can also be applied to any field implementing seismic data acquisition in a marine environment.

During marine seismic acquisition operations, networks of sensors—most typically hydrophones, geophones, or accelerometers—are deployed at or beneath a surface of a body of water. For example, hydrophones are distributed along tubular cables to form linear acoustic antennas, commonly known as ‘seismic streamers’. In general a network of these seismic streamers, known as a seismic array, is towed by a marine vessel. Seismic arrays can comprise of up to ten or more individual streamer cables, each of which streamer cables may be up to 10 km in length.

Seismic exploration campaigns can be scheduled to last several months and often one vessel may spend a period of activity in one geographical location then move to a new location to begin a further period of seismic data acquisition. Given the length of the streamer networks it is avoided, as much as possible, to return (by reeling) the streamers bank onto the vessel, as the process is operationally difficult and time consuming. This results in the streamer arrays spending consecutive months, often 6-12 months, immersed in water. Moreover, the streamers are towed at a depth of approximately 5 meters below the surface of the water and are towed at a speed that rarely exceeds 5 km/h. Seismic streamers are thus prone to fouling by marine organisms such as ‘slime’ and barnacles.

FIG. 1 illustrates a seismic streamer fouled by barnacles following a period of deployment in the Gulf of Mexico.

Fouling of seismic streamers can generate several problems:

1. The drag of seismic streamers is increased which consequently results in increased fuel consumption.

2. The induced increase in mass on the streamer can cause direct and indirect damage due to increased strain on stress members.

3. Hydrodynamic flow noise is created by the biofouling that in severe cases may reduce the acoustic signal-to-noise performance of the acquisition system.

4. Personnel are put at risk as work need to be deployed in order to perform manual removal of the fouling organisms using scraping devices. The process is highly time consuming and results in economically costly lost-production time. Moreover due to the sharp nature of the hand-held devices used to physically remove fouling organisms, the process is often coupled with damage to the integrity of the seismic streamer tubing.

A typical seismic steamer comprises sensors, strength members and cabling housed all disposed within a polyurethane casing. The casing may be manufactured from an extruded layer of flexible polyurethane tubing or the like that functions to protect the components of the streamer from the marine environment. It is the outer surface of this casing that provides a surface suitable for biofouling, such as barnacle colonization or the like. Although casing materials, such as polyurethane, are typically difficult to chemically or biologically adhere to, biofouling, by barnacles in particular, is problematic in the marine seismic industry.

There are several steps that culminate in the barnacle colonization process. Once the steamer surface is immersed in water it is immediately covered with a thin ‘conditioning’ film consisting mainly of proteins and other dissolved organic molecules. This step is followed by the adhesion of single floating bacteria. Once attached bacteria begin to generate extra-polysaccharide (“EPS”) layers that result in inter-bacterial network formation and enhanced adhesion to the immersed surface of the seismic streamer. This process is generally termed micro-fouling and results in biofilm formation on the streamer. The micro-fouling process is believed to strongly contribute to a pursuant rapid colonization by macro-foulers (e.g. barnacles) as the biomass-rich biofilm provides a readily-available food source.

Antifouling paints have long been the most effective method to prevent macrofouling of steel-hulled marine vessels. In such paints, biocides or heavy metal compounds, such as tributyltin oxide (“TBTO”) are released (leached) from the paint to inhibit microorganism attachment. Typically these paints are composed of an acrylic polymer with tributyltin groups attached to the polymer via an ester bond. The organotin moiety has biocidal properties and is acutely toxic to the attached organisms. TBT compounds are historically the most effective compounds for biofouling prevention, affording protection for up to several years.

Unfortunately, TBT compounds are also toxic for non-target marine organisms. Furthermore, TBT compounds are not biodegradable in water and, as a result, the compounds may accumulate in water and pose an environmental hazard. As a result, the International Maritime Organization (“IMO”) banned the application of TBT compounds in 2003, and required the removal of all TBT coatings, worldwide by 2008. Alternative strategies have thus been sought that have much lower general toxicity and as such are more environmentally acceptable.

In the seismic industry, the systems and methods of preventing the biofouling of seismic streamer used to acquire seismic data comprise incorporating biocides in the streamer skin and applying paints or attaching coatings to the streamer skin; the skin of the seismic streamer is typically a polyurethane layer/envelope that surrounds the sensor system of the seismic streamer. As such, the generation of an antifouling strategy for seismic streamers has previously focused primarily on two different approaches.

The first general strategy for preventing fouling on seismic streamers is based on the incorporation of a biocidal compound within the polyurethane skin. A wide array of chemicals are known to be anti-microbial by nature. These anti-microbial chemicals include various polymers—e.g. polyethylene oxide, polyacrylamide—quaternary ammonium salts—e.g. benzylalkonium chlorine—and organic compounds—such as Diuron. With regard to seismic streamers, compounds have been incorporated into the polyurethane tubing that are biologically active against organisms that settle on the surface of the tubing and, therefore the chemicals act as a post-settlement strategy. One issue with the antifouling approach of using biocides is that while the biocide kills organisms on the surface of the streamer, the organism is not removed. As such, the biofouled surface remains on the streamer and may act as a colonization initiation point for continued fouling.

The second approach involves applying a silicone-based coating to the skin of the streamer, which coating acts to prevent the initial adhesion, or aids with the removal of macro-fouling organisms by generation of a hydrophobic/high contact angle streamer surface. Silicones have unique properties that make them useful as antifouling coatings. Silicone-based coatings are typically based on the incorporation of polydimethylsiloxane (“PDMS”) into a coating that is applied to a surface of the seismic streamer. PDMS comprises methyl (CH₃) side chains that give rise to a low surface energy (20-24 mJ/m²) and a silicon oxide (—Si—O) backbone linkage that creates an extremely low elastic modulus (˜1 MPa). Both these properties of PDMS are believed to be essential to the low adhesion properties of the silicone coatings.

The typical skin of a seismic streamer comprises polyurethane, which is a substrate on which it is difficult to chemically and or physically adhere the hydrophobic/high contact angle antifouling coatings of the prior art. A method of overcoming the issues of chemical adhesion of silicon polymers to polyurethane as well as the resulting break-down/destruction of the polymer coating with ageing is based on the application of an intermediate layer (tie-coat) to the polyurethane followed by application of a silicone-elastomer coating that is adhered to the intermediate tie-coat layer via a heat-curing process. However, in field experiments, although the silicone-outer layer applied to the skin of the streamer in this way was demonstrated to prevent barnacle-fouling in the short term, after a certain period of time, de-lamination of the outer silicone elastomer coating was observed.

Moreover, in the field testing, de-lamination of the coating from the polyurethane tube was exacerbated daring the operational process of reeling streamers onto and off marine vessels before and after seismic shooting. The propensity of silicone coatings to delaminate from the polyurethane streamer skin is an intrinsic property doe to the intrinsically low resistance of the coatings to abrasion. Notably, in areas in which delamination was most evident, rapid barnacle-colonization of the streamer surface was observed. In fact, the prior art method of laminate silicon polymer coatings may, in the long run, actually increase biofouling.

As discussed above, the previous methods of addressing biofouling of seismic streamers have been to apply coatings or paints to the streamer skin. The application of coatings and paints to the streamer have been pursued as the paints and coatings can be applied directly to a formed streamer casing/skin and, as such, there is no issue about, among other things, of the coating and/or paint interacting with the constituents of the streamer skin, adversely affecting the fabrication of the streamer skin, degrading the durability/effectiveness of the streamer skin and/or interacting with the internal elements of the seismic streamer; for example, many seismic streamers comprise kerosene as a void filling material within the streamer, and the kerosene may adversely interact with the constituents of the coating or paint. As a solution to biofouling, the application of coatings and paints to the skin of the seismic streamer has not been effective because of the break down/disintegration/delamination of such coatings and paints under field conditions.

### BRIEF SUMMARY

In an embodiment of the present invention, an anti-biofouling casing for a seismic streamer is provided, the anti-biofouling casing comprising a polymer system comprising a hydrophobically-modified base polymer, the hydrophobically-modified base polymer comprising a base polymer having a backbone and a hydrophobic chain extender and/or a hydrophobically derivatized chain extender coupled to said backbone of said base polymer, wherein the hydrophobic chain extender/hydrophobically derivatized chain extender comprises a hydrophobic moiety. In certain aspects of the present invention, the hydrophobic moiety comprises at least one of a fluorine derivative, a silicon derivative and a polyethylene glycol derivative.

In certain embodiments of me present invention, the polymer system comprises an (AB)ₙ type block copolymer, wherein the (AB)ₙ type block copolymer comprises a soft polyol segment and a hard segment comprising the hydrophobically-modified base polymer.

In some embodiments, the pre-polymer comprises one of polyurethane, thermoplastic polyurethane, urethane, polyvinylchloride and polyethylene and the chain extender comprises one of a fluorine derivatised chain extender, a silicone derivatised chain extender and a glycol derivatised chain extender.

In one embodiment of the present invention, a method of fabricating a seismic streamer using an anti-biofouling casing comprising a base polymer with a hydrophobic moiety chemically reacted onto the backbone of said base polymer is provided, the method comprising extruding the anti-biofouling casing onto the seismic streamer. In another embodiment of the present invention, a method of fabricating a seismic streamer using an anti-biofouling casing comprising a base polymer with a hydrophobic moiety chemically reacted onto the backbone of said base polymer is provided, where the anti-biofouling casing is extruding to form a tube and the seismic streamer is inserted into the extruded tube of the anti-biofouling casing.

In aspects of the present invention, a method of fabricating a polymer system for use for use as an anti-fouling casing is provided, the method of fabrication comprising reacting a polyol with diisocyanate to form a diisocyanate terminated intermediate oligomer and reacting the intermediate oligomer with a chain extender comprising a hydrophobic moiety.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The present invention will become more fully understood from the detailed description and the accompanying drawings, wherein:

FIG. 1 is an illustration depicting biofouling of a marine seismic streamer;

FIG. 2 illustrates a cross-section of a marine seismic streamer;

FIG. 3A illustrates contact angles for effective aqueous glue attachment of an organism to a polyurethane surface;

FIG. 3B illustrates a contact angle on a polyurethane surface;

FIG. 3C; illustrates contact angles for ineffective aqueous glue attachment of an organism to a silicon coated polyurethane surface;

FIG. 4A illustrates a thermo-polyurethane (“TPU”) block copolymer;

FIG. 4B illustrates a TPU block copolymer with a hydrophobically derivatized chain extender, in accordance with an embodiment of the present invention;

FIG. 4C illustrates a streamer skin comprising a TPU block copolymer in accordance with an embodiment of the present invention; and

FIG. 5 illustrates a method of fabricating a seismic streamer skin with a hydrophobically modified surface.

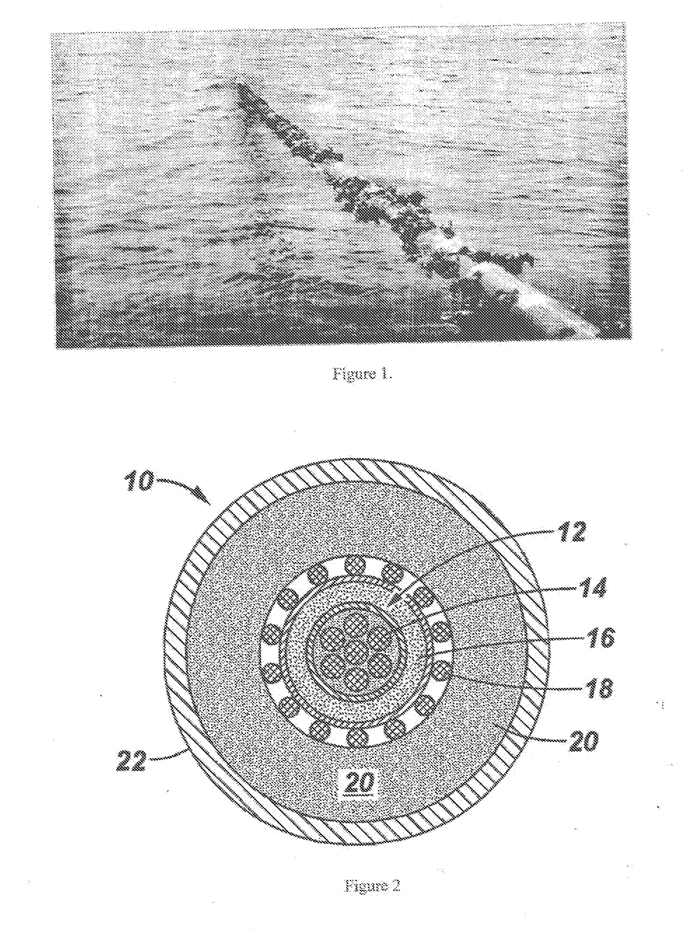

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc, may be passed, forwarded, or transmitted via any suitable means including memory sharing, message passing, token passing, network transmission, etc.

Embodiments of the invention aim, among other things, to overcome the disadvantages of existing seismic streamer casings. More precisely the invention is a streamer skin (or a streamer tubing) that can resist adhesion of marine organisms such as, but not limited to, biofouling by among other things marine slime, barnacles and/or the like, in an embodiment of the present invention the antifouling aspect of the invention is integrated within the seismic streamer casing/tubing daring the casing/tubing manufacturing process. Embodiments of the present invention, circumvents issues of having to apply a paint or a coating to the casing/tubing post-manufacture of the casing/tubing in order to provide the casing/tubing with anti-biofouling properties. The post-manufacture application of paints or coatings to the casing/tubing provide for poor adhesion of the paint/coating with the casing/tubing and/or premature removal of the paint/coating from the surface of the tubing/casing during exposure or use. Furthermore, embodiments of the present invention provide that antifouling chemistry is ‘locked into’ the streamer tubing and therefore antifouling properties are resilient and may even be retained for the duration of the streamer's operational life. Therefore, some embodiments of the present invention provide a formulation for a seismic streamer skin material offering inherent antifouling properties.

Some embodiments of the present invention provide a skin that can be need to contain the acoustic equipment of a towed sonar line array and retain the mechanical and physical constraints linked with the streamer tubing inventory that is currently in operation.

FIG. 2 illustrates a cross-section of a marine seismic streamer. The streamer 10 includes a central core 12 having a transmission bundle 14 surrounded by a strength member 16. The central core 12 is typically prefabricated before adding sensors and/or sensor electronics. Local wiring 18, which is used to connect the sensor and sensor electronics, is also disposed in the streamer 10 inside of a body 20 and a skin 22. In certain aspects, the body 20 may comprise a polymer body, a support structure and/or the like for holding the internal mechanisms of the streamer 10.

The body 20 may be filled with a liquid, gel, solid and/or the like to provide for communication of the internal mechanisms of the streamer 10 with the water surrounding the streamer. In general, seismic streamers have been filled with liquid kerosene to provide for communication of the internal mechanisms of the streamer 10 with the water surrounding the streamer. As such, the composition of the skin 22 has been an issue with respect to the constituents of the skin 32 since the kerosene may adversely internet with certain constituents of the skin 22.

The typical way to dispose the wiring 18 within the streamer cable 10 is to twist the wiring onto the central core 12 with a certain lay-length (or pitch) to allow for tensile cycling and bending of the streamer cable 10 without generating high stresses in the wires. Wiring layers in cables are often pre-made with the central core 12.

In some embodiments of the present invention, the streamer 10 may comprise a field streamer, comprising a fluid such as kerosene. In other embodiments of the present invention the streamer 10 may compose a solid streamer with a solid/gel-type material disposed around the core of the streamer 10. Merely by way of example, for solid streamers it may be of importance to prevent biofouling so that the solid streamer may be maintained and for proper operation of the solid streamer. As such, by using an anti-biofouling system and method in accordance with an embodiment of the present invention, the operation of the solid streamer may be enhanced.

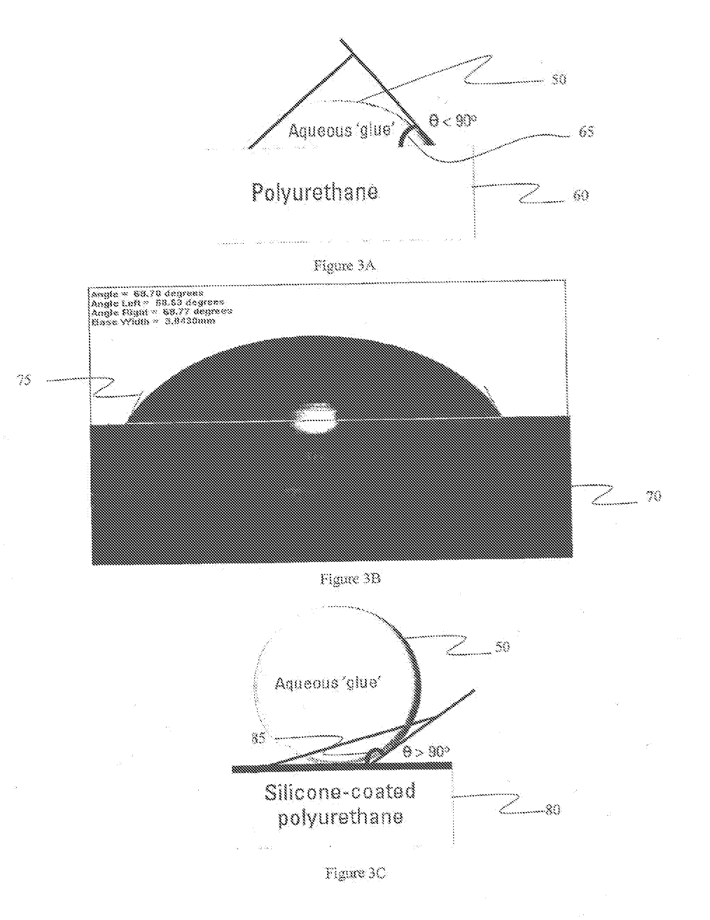

FIG. 3A is a schematic representation of how a marine organism attaches to a surface. As depicted, a barnacle (not shown) uses an aqueous glue 50 to attach to a polyurethane surface 60. The aqueous glue 50 comprises an aqueous based mixture of proteins and polysaccharides excreted by the barnacle larvae to enable adhesion. Initial adhesion is promoted by provision of a hydrophilic surface such as a typical seismic streamer surface, wherein the hydrophilic surface provides a contact angle 60 that is less than 90 degrees.

FIG. 3B illustrates a contact angle for an untreated polyurethane streamer casing. An untreated skin 70 of the seismic streamer in FIG. 3 is relatively water wetting with a contact angle 75 of about 68.70°. As such, the untreated skin 70 is hydrophilic and prone to biofouling.

FIG. 3C is a schematic representation of how an initial attachment of marine organisms to surfaces can be reduced via provision of hydrophobic surfaces (contact angle greater than 90 degree). As provided in FIG. 3C, a treated surface 80 comprises polyurethane with a silicon coating. The silicon coating causes a contact angle 85 of the treated surface 80 to be greater than 90 degrees. As a result of the contact angle 85 being greater than 90 degrees a marine organism (not shown), in this example a barnacle larvae cannot, adhere to the a treated surface 80 using an aqueous glue 50 comprising an excreted aqueous based mixture of proteins and polysaccharides.

Changes to the contact angle of the skin of the seismic streamer may be produced by applying a coating. A large change in the contact angles was observed with the application of a silicone coating, such as an aminoalkyl functionalized polydimethylsiloxane. However, such a silicone coating is very difficult to apply to a streamer skin due to the contrast in the chemical nature of the coating and the polyurethane material of the seismic streamer skin. Furthermore, Applicants have observed that in brine at 40° C., an ageing process takes affect on the coated polyurethane streamer skin leading to the removal of the coating from the streamer surface. This removal of the coating due to ageing leaves areas of the original polyurethane exposed and at risk of biofouling.

As discussed above, because of the issues inherent to coating strategies, in particular poor adhesion and premature removal from the polyurethane surface during exposure or use, an alternative approach is required to generate, among other things, a durable antifouling technology that can prevent biofouling over an extended period of operation of a seismic streamer.

Seismic streamers are generally fabricated from TPU. TPU is formed by the reaction of: (1) diisocyanates with short-chain diols, referred to as chain extenders and (2) diisocyanates with long-chain bifunctional diols (known as polyols). The virtually unlimited amount of possible combinations for varying the structure and/or molecular weight of the three reaction compounds make it possible to fabricate an enormous variety of different TPUs.

TPU resin consists of linear polymeric chains in block-structures, where the linear chains contain low polarity segments, called soft segments, and are alternated in the resin with shorter, high polarity segments called hard segments. Both types of segments are linked together/coupled by covalent links/bonds to form block-copolymers.

The polarity of the hard segments creates a strong attraction between the hard segments, which causes a high degree of aggregation and order in the hard segment phase of the TPU. As such, the hard segment phase forms crystalline or pseudo crystalline areas that are disposed in a soft and flexible matrix. The crystalline or pseudo crystalline areas of the hard phase of the block copolymer act as physical crosslinks providing for the high elasticity level of TPU, whereas the flexible chains provide the elongation characteristics to the polymer. It is this combination of properties of the TPU block copolymer system that make it desirable for use in seismic streamers.

As discussed above, thermoplastic polyurethanes are a versatile group of multi-phase segmented polymers that have excellent mechanical and elastic properties, good hardness and high abrasion and chemical resistance. Generally, polyurethane block copolymers are comprised of a low glass transition or low melting ‘soft’ segment and a rigid ‘hard segment’, which often has a glassy Tg or crystalline melting point well above room temperature.

For seismic streamer skins, the soft segment is typically a dihydroxy terminated long chain macroglycol with a molecular weight between 500-5000 grammes per mole, though in practice, molecular weights of 1000 and 2000 grammes per mole, are primarily used. They include polyethers, polyesters, polydienes or polyolefins. The hard segment normally includes the reaction product of a disocyanate (aliphatic or aromatic) and a low-molecular weight diol or diamine (referred to as a ‘chain extender’). The role of the chain extender will be discussed further below. The combination of this soft polyol segment and hard segment forms an (AB)n type block copolymer

Polyurethane elastomers usually exhibit a two-phase microstructure. The microphase separation, or microdomain formation, results in superior physical and mechanical properties. The degree of separation or domain formation depends on the weight ratio of the hard to soft segment, the type and molecular weight of the soft segment, the hydrogen bond formation between the urethane linkages and the manufacturing process and reaction conditions, including the addition/use of catalysts. A further key component that may be used to tune the microdomain formation, and thus the final properties of the polyurethane block copolymer, is the role performed by the chain extender.

In the most common method of polyurethane production, i.e. via a two-step synthesis, or ‘pre-polymer’ route, the polyol is initially reacted with excess diisocyanate to form a diisocyanate terminated intermediate oligomer. The prepolymer is typically a viscous liquid or low melting point solid. The second step is to convert this prepolymer to the final high molecular weight polyurethane by further reaction with a low molecular weight diol chain extender—for example, 1,4-butanediol, 1,6-hexanediol—or a diamine chain extender—for example ethylene diamine, 4,4′-methylene bis(2-chloroaniline). This step is generally referred to as chain extension.

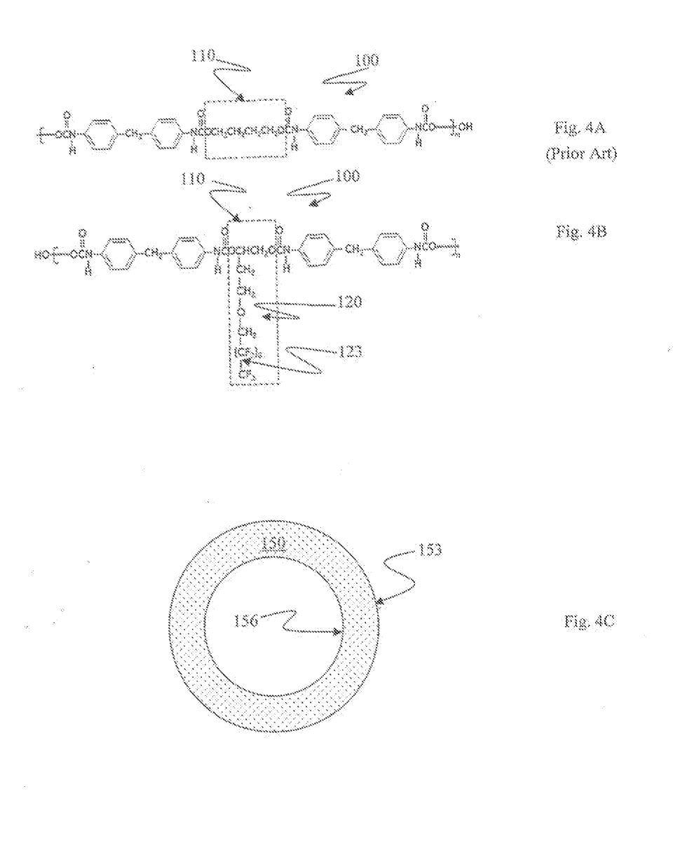

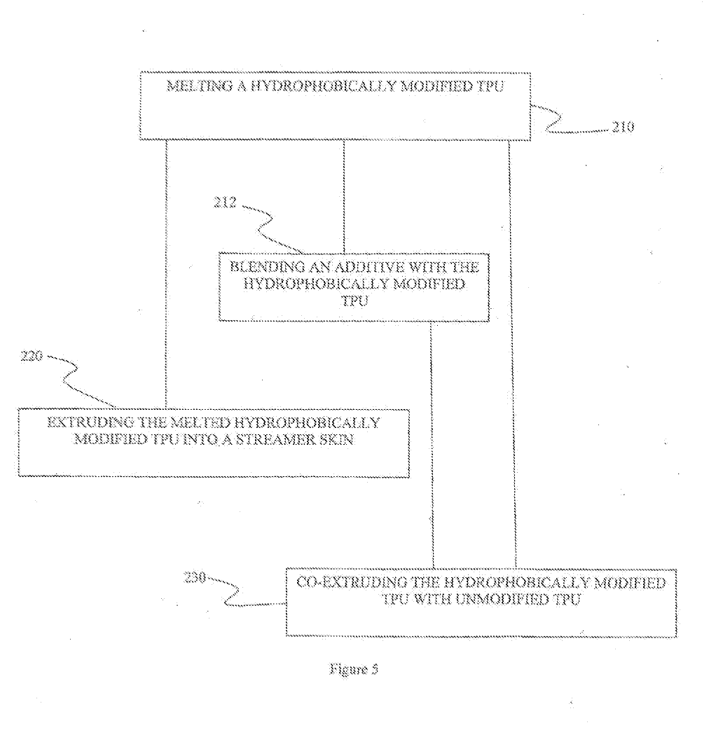

FIG. 4A illustrates a TPU block copolymer as discussed above. As depicted, a TPU block copolymer 100 comprises a backbone 110. In a conventional seismic streamer skin, a chain extender (not shown) may be coupled with the backbone of the TPU block copolymer 100. The chain extender may comprise a diol or a diamine chain extender. In the absence of a chain extender, a polyurethane formed by directly reacting diisocyanate and polyol generally has very poor physical properties and often does not exhibit microphase separation. Thus, the introduction of the chain extender in a conventional seismic streamer skin material can increase the hard segment length of the material, to permit hard segment segregation, which results in modified mechanical properties, such as an increase in the hard segment glass transition temperature (Tg) of the polymer.

FIG. 4B illustrates a TPU block coploymer with a hydrophobically derivatized chain extender, in accordance with an embodiment of the present invention. In accordance with an embodiment of the present invention, a hydrophobically derivatised chain extender 120 is coupled with the backbone 110 of the TPU block copolymer 100. In certain embodiments of the present invention, the hydrophobically derivatised chain extender 120 may comprise a fluorinated or silicone derivatised species chosen from either of the two categorized main classes; namely the aromatic diol and diamine classes, and the corresponding aliphatic diol and diamine classes.

In FIG. 4B, in accordance with one embodiment of the present invention, the hydrophobically derivatised chain extender 120 comprises fluorine moieties 123. In other, aspects of the present invention, the derivatised chain extender 120 may comprise other hydrophobic moieties, such as silicon or the like.

In an embodiment of the present invention, to incorporate a fluorine moiety into the TPU backbone, a fluorinated chain extender may be used. These chain extenders are commercially available and may comprise perfluoroether diols or the like. In certain aspects of the present invention, the chemistry used for attaching the fluorinated chain extenders may be based on two monomers, namely hexafluoropropene or tetrafluoroethylene.

In other embodiments of the present invention, to incorporate silicone onto the TPU backbone, a siloxane chain extender is used. Merely by way of example, 1,3-bis(4-hydroxybutyl)-1,1,3,3-tetramethyldisiloxane and 1,3-bis(4-aminopropyl)-1,1,3,3-tetramethyldisiloxane may be used to yield a TPU that comprises siloxane chain extenders coupled with the backbone of the TPU.

In yet other embodiments of the present invention, rather than using a fluorine or silicone derivatised chain extender to yield a polyurethane/TPU with hydrophobic surface properties, a chain extender may be utilized that is chosen from the polyethylene glycol (“PEG”) family. PEG molecules are hydrophobic and, as such, in aspects of the present invention the use of relatively low molecular weight (100-100,000 grammes per mole) PEG molecules—such as amine terminated PEGs, alcohol terminated PEGs and/or the like—as chain extenders provide for a TPU material that may be used to produce a streamer skin having surface anti-fouling properties.

The use of hydrophobic chain extenders in polyurethane has a limit with regard to the amount of hydrophobic modification that can be achieved. As such, in some embodiments of the present invention, to enhance the amount of hydrophobicity within the TPU polymer system, the hydrophobic chain extenders may be used in conjunction with a filler configured to increase the hydrophobic properties of the TPU and, as a consequence, make the material more resistant to bio-fouling. In aspects of the present invention, the fillers may comprise relatively high molecular weight hydrophobic polymers, typically in a solid form that can be blended or mixed with the hydrophobically modified polyurethane. Merely by way of example, hydrophobic additives that may be used in conjunction with a hydrophobically modified TPU, in accordance with an embodiment of the present invention, include polyethylene, polyisobutylene or polystyrene.

Merely by way of example, in one embodiment of the present invention, a hydrophobically modified polyurethane—which may be hydrophobically modified by linking the TPU backbone with chain extenders containing silicone moieties, fluorine a moieties and/or the like—may be blended with polytetrafluoroethylene (“PTFE”) or polydimethylsiloxane (“PDMS”) granules/pellets. In certain aspects, the PTFE may a micronized PTFE, which is commercially available.

In some aspects of the present invention, the hydrophobic additive may be blended with the hydrophobically modified TPU base material during a melt processing stage. The mixture may then be heated and extruded into pellets. In an embodiment of the present invention, the pellets may be heat extruded to form the streamer skin. The pellets may, in some aspects of the present invention, be extruded directly onto the streamer. In other aspects of the present invention, the pellets may be extruded to form a streamer skin of desired specifications, i.e. outer diameter, inner diameter, length, etc.. By creating a streamer skin of desired dimensions, the streamer body may be inserted into the streamer skin post extrusion. In aspects of the present invention, the streamer body may comprise a filler material, which may be a liquid filler, a solid filler, a gel filler and/or the like. In some aspects of the present invention, the pellets may be co-extruded with pellets of unmodified TPU to provide a streamer skin having hydrophobic properties that differ across the skins diameter. In some embodiments of the present invention, the filler material is selected to produce a streamer skin that, among other things, is more durable, has anti-fouling properties and provides an increased resistance to physical damage such as wear or abrasion.

In some embodiments of the present invention, the molecular additive is a solid. In other embodiments of the present invention, the molecular additive is a liquid that may be introduced into the melt processing stage via a preliminary stage. Merely by way example, the preliminary stage may comprise coating a TPU base material with the liquid molecular additive and then drying the coated TPU base material. The coated TPU base material may then be melted, extruded and pelleted. The produced pellets may then be blended with unmodified TPU to generate a modified TPU wife increased wear-resistance and/or hydrophobic properties. Thus, embodiments of the present Invention, provide that liquid-based additives, snob as silicone, fluoro polymers or fluorosilicone containing species may be used as molecular additives that may be used with the hydrophobically modified TPU.

FIG. 4C illustrates a streamer skin comprising a TPU block copolymer in accordance with an embodiment of the present invention. As depicted in FIG. 4C, a streamer skin 150 comprises the TPU block copolymer with the hydrophobic chain extenders. By using the TPU block copolymer with the hydrophobic chain extenders—the hydrophobic chain extenders comprising hydrophobic elements such as silicon, fluorine and/or the like—to form the streamer skin 150, the hydrophobic moieties are distributed throughout the streamer skin 150 including at an outer-surface 153 and an inner-surface 156 of the streamer skin 150. In an embodiment of the present invention, the outer-surface 153 is modified by the presence of the hydrophobic elements such that the outer-surface 153 is hydrophobic, has a high contact angle and imparts antifouling properties to the seismic streamer.

In an embodiment of the present invention, the TPU block copolymer comprising the hydrophobically modified chain extenders is extruded to produce a seismic streamer skin. For example, the TPU block copolymer comprising the hydrophobically modified chain extenders may comprise pellets that may be heated and extruded into the streamer skin configuration. The extrusion method disperses the hydrohobic moieties both through the bulk matrix and at the surface of the streamer skin.

In an embodiment of the present invention, the streamer skin may be fabricated by reacting the hydrophobic chain extenders with a prepolymer to produce the hydrophobically-modified thermoplastic polyurethane (TPU). In this way, the hydrophobic moieties are chemically reacted into the hard segments of the polyurethane backbone. In an embodiment of the present invention, by reacting the hydrophobic moieties into the hard segments of the polyurethane backbone, a thermoplastic polyurethane block copolymer is produced that exhibits a two-phase microstructure. The hydrophobic moieties, which may comprise fluorine, silicone or the like, may in some aspects be dispersed essentially homogenously throughout the TPU; the hydrophobic moieties being localized predominantly in the hard, rigid segments (glassy or semicrystalline domains) and also dispersed within the polyol soft (amorphous, rubbery) segments of the block copolymer.

In an embodiment of the present invention, the hydrophobically modified TPU can be used as the polyurethane master batch to produce seismic streamer tubing. As fluorine/silicone is dispersed throughout the TPU master batch, following the extrusion process, a streamer skin is produced which yields a hydrophobic, low-energy surface. The incorporation of hydrophobic derivatised chain-extenders, such as fluorine or silicon derivatised chain extenders, into the polyurethane synthesis reaction will thus impart a change in the surface chemistry upon the thermoplastic polyurethane such that it is less water-wetting than its non-modified counterpart. In an embodiment of the present invention, this change in the surface wettability makes the resulting extruded streamer tubing surface less susceptible to bio-fouling.

In embodiments of the present invention, the streamer skin may comprise biocidal additives in addition to the antifouling additives. In certain aspects, the biocide may take the form of, but is not limited to, nanoparticles of silver, copper oxide or zinc oxide, quaternary ammonium salts and organic species, such as benzoic acid, tannic acid or capsacain. In an embodiment of the present invention, the biocide may be blended with the antifouling additives prior to blending with the base material of the streamer skin. In other embodiments, the biocidal materials may be coated on the streamer skin, which streamer skin includes the hydrophobically modified chain extenders. The biocidal elements may prevent the build-up of marine species, including micro-foulers (which are food sources for the macrofoulers), on the seismic streamer.

FIG. 5 illustrates a method of fabricating a seismic streamer skin with a hydrophobically modified surface. In step 210, a hydrophobically modified TPU is melted. The hydrophobically modified TPU, as discussed above, comprising chain extenders containing hydrophobic moieties.

In step 220 the melted hydrophobically modified TPU is extruded into a seismic streamer, where the chain extenders containing hydrophobic moieties provide that the extruded seismic streamer has a surface, the inner/outer surface of the streamer skin, that is hydrophobic.

In step 212, an additive may be blended with the melted hydrophobically modified TPU. The mixture produced in step 212 may then be extracted in step 220 into the streamer skin. The additive may comprise hydrophobic moieties, moieties that increase the strength of the hyydrophobically modified TPU and/or the like. The additive may comprise pellets that are melted with pellets of the hydrophobically modified TPU. In some aspects of the present invention, the additive may comprise a biocide.

In step 230, the hydrophobically modified TPU may be co-extruded with unmodified TPU. In this way, a streamer skin may be provided that consists of two skins that are annealed together, the two skins having a hydrophobically modified region and an unmodified region of TPU separated by a region having varying amounts of hydrophobic modification. In this way, a streamer skin may be produced having an outer surface comprising hydrophobically modified TPU and having hydrophic properties an inner-surface comprising unmodified TPU and not having hydrophobic properties or, in some aspects even having hydrophilic properties. In certain aspects, the hydrophobically modified TPU may be simultaneously heat extruded with the unmodified TPU to form a multilayer polymer. In some aspects, the multilayer polymer may be extruded onto the seismic streamer. In other aspects, the multilayer polymer may be formed into a seismic streamer skin of desired dimensions into which a streamer body may be inserted.

In an embodiment of the present invention, by simultaneously heat extruding the two mixtures, the TPU polymers anneal with one another, effectively integrates across the layer comprising the regular TPU and the hydrophobically modified TPU to form a multilayer polymer that does not include a boundary layer, thus, preventing the disintegration, delamination issues that occur when a coating is applied to a streamer skin.

While the principles of the disclosure have bean described above in connection with specific apparatuses and methods, it is to be clearly understood that this description is made only by way of example and not as limitation on the scope of the invention.

What is claimed is:

1. An anti-biofouling casing for a seismic streamer, comprising:
a polymer system comprising a hydrophobically-modified base polymer, wherein the hydrophobically-modified base polymer comprises a base polymer having a backbone and a hydrophobically derivatized chain extender coupled to said backbone of said base polymer.

2. The anti-biofouling casing of claim 1, wherein the hydrophobically derivatized chain extender comprises a hydrophobic moiety.

3. The anti-biofouling casing of claim 2, wherein the hydrophobic moiety comprises at least one of a fluorine derivative, a silicon derivative and a polyethylene glycol derivative.

4. The anti-biofouling casing of claim 1, wherein the base polymer comprises one of polyurethane, thermoplastic polyurethane, urethane, polyvinylchloride and polyethylene.

5. The anti-biofouling casing of claim 1, wherein the polymer system comprises an (AB)ₙ type block copolymer, and wherein the (AB)ₙ type block copolymer comprises a soft polyol segment and a hard segment comprising the hydrophobically-modified base polymer.

6. The anti-biofouling casing of claim 5, wherein the (AB)ₙ type block copolymer has a two-phase microstructure.

7. The anti-biofouling casing of claim 5, wherein the soft polyol segment comprises a dihydroxy terminated long chain macroglycol.

8. The anti-biofouling casing of claim 1, further comprising a biocide.

9. The anti-biofouling casing of claim 1, further comprising a hydrophobic polymer filler.

10. The anti-biofouling casing of claim 9, wherein the hydrophobic polymer filler comprises at least one of polytetrafluoroethylene, polydimethylsiloxane and polyethylene, polyisobutylene and polystyrene.

11. The anti-biofouling casing of claim 1, wherein the hydrophobically-modified base polymer is produced by reacting a pre-polymer with the hydrophobically derivatized chain extender.

12. The anti-biofouling casing of claim 11, wherein:
the pre-polymer comprises one of polyurethane, thermoplastic polyurethane, urethane, polyvinylchloride and polyethylene.

13. The anti-biofouling casing of claim 9, wherein the hydrophobic polymer filler is homogeneously dispersed throughout the anti-biofouling casing.

14. The anti-biofouling casing of claim 1, further comprising;
a streamer body, wherein:
the streamer body comprises one or more sensors, a strength member and a filler material; and
the anti-biofouling casing covers an exterior of the streamer body.

15. The anti-biofouling casing of claim 14, farther comprising;
a streamer skin.

16. The anti-biofouling casing of claim 15, wherein the streamer skin comprises one of polyurethane, thermoplastic polyurethane, urethane, polyvinylchloride and polyethylene.

17. The anti-biofouling casing of claim 14, wherein the filler comprises at least one of kerosene, a solid material and a gel.

18. A method of fabricating a seismic streamer using an anti-biofouling casing according to claim 1, comprising;
extruding the anti-biofouling casing onto the seismic streamer.

19. A method of fabricating a seismic streamer using an anti-biofouling casing according to claim 1, comprising:
extruding the anti-biofouling casing as a tube; and
inserting the seismic streamer into the extruded tube of the anti-biofouling casing.

20. The method of fabricating the seismic streamer using the anti-biofouling casing according to claim 14, comprising;
extruding the anti-biofouling casing onto the seismic streamer.

21. A method of manufacturing an anti-biofouling seismic streamer, comprising:
extruding a polymer system onto a seismic streamer body, wherein the polymer system comprises a hydrophobically-modified base polymer and the hydrophobically-modified base polymer comprises the base polymer with a hydrophobic moiety chemically reacted onto a backbone of said base polymer.

22. The method of claim 21, wherein the step of extruding the polymer system onto the seismic streamer body comprises extruding the polymer system into a tube and inserting the seismic streamer body into the extruded tube.

23. The method of claim 21, wherein the hydrophobically-modified base polymer comprises at least one of a one of a fluorine derivatised chain extender, a silicone derivatised chain extender and a glycol derivatised chain extender.

24. A method of fabricating a polymer system for use in the method of manufacturing an anti-fouling seismic streamer of claim 21, comprising:
reacting a polyol with diisocyanate to form a diisocyanate terminated intermediate oligomer; and
reacting the intermediate oligomer with a chain extender comprising a hydrophobic moiety.

25. The method of claim 24, wherein the chain extender comprises at least one of a low molecular weight diol and low molecular weight diamine.
